(19) United States
(12) Patent Application Publication
(10) Pub. No.: US 2018/0081041 A1
(43) Pub. Date: Mar. 22, 2018

(54) LiDAR with irregular pulse sequence

(71) Applicant: APPLE INC., Cupertino, CA (US)

(72) Inventors: Cristiano L. Niclass, San Jose, CA (US); Alexander Shpunt, Portola Valley, CA (US); Gennadiy A. Agranov, San Jose, CA (US); Thierry Oggier, San Jose, CA (US)

(21) Appl. No.: 15/586,300

(22) Filed: May 4, 2017

Related U.S. Application Data
(60) Provisional application No. 62/397,940, filed on Sep. 22, 2016.

(51) Int. Cl. G01S 7/486; G01S 17/10; G01B 11/22; G01S 17/89

(52) U.S. Cl. CPC G01S 7/4863; G01S 17/89; G01B 11/22; G01S 17/10

(57) ABSTRACT

Depth-sensing apparatus includes a laser, which is configured to emit pulses of optical radiation toward a scene, and one or more detectors, which are configured to receive the optical radiation that is reflected from points in the scene and to output signals indicative of respective times of arrival of the received radiation. Control and processing circuitry is coupled to drive the laser to emit a sequence of the pulses in a predefined temporal pattern that specifies irregular intervals between the pulses in the sequence, and to correlate the output signals with the temporal pattern in order to find respective times of flight for the points in the scene.

### CROSS-REFERENCE TO RELATED APPLICATION

This application claims the benefit of U.S. Provisional Patent Application 62/397,940, filed Sep. 22, 2016, whose disclosure is incorporated herein by reference.

### FIELD OF THE INVENTION

The present invention relates generally to range sensing, and particularly to devices and methods for depth mapping based on time-of-flight measurement.

### BACKGROUND

Time-of-flight (ToF) imaging techniques are used in many depth mapping systems (also referred to as 3D mapping or 3D imaging). In direct ToF techniques, a light source, such as a pulsed laser, directs pulses of optical radiation toward the scene that is to be mapped, and a high-speed detector senses the time of arrival of the radiation reflected from the scene. The depth value at each pixel in the depth map is derived from the difference between the emission time of the outgoing pulse and the arrival time of the reflected radiation from the corresponding point in the scene, which is referred to as the “time of flight” of the optical pulses. The radiation pulses that are reflected back and received by the detector are also referred to as “echoes.”

Single-photon avalanche diodes (SPADs), also known as Geiger-mode avalanche photodiodes (GAPDs), are detectors capable of capturing individual photons with very high time-of-arrival resolution, on the order of a few tens of picoseconds. They may be fabricated in dedicated semiconductor processes or in standard CMOS technologies. Arrays of SPAD sensors, fabricated on a single chip, have been used experimentally in 3D imaging cameras. Charbon et al. provide a useful review of SPAD technologies in “SPAD-Based Sensors,” published in TOF Range-Imaging Cameras (Springer-Verlag, 2013).

### SUMMARY

Embodiments of the present invention that are described hereinbelow provide improved LiDAR systems and methods for ToF-based ranging and depth mapping.

There is therefore provided, in accordance with an embodiment of the invention, depth-sensing apparatus, including a laser, which is configured to emit pulses of optical radiation toward a scene, and one or more detectors, which are configured to receive the optical radiation that is reflected from points in the scene and to output signals indicative of respective times of arrival of the received radiation. Control and processing circuitry is coupled to drive the laser to emit a sequence of the pulses in a predefined temporal pattern that specifies irregular intervals between the pulses in the sequence, and to correlate the output signals with the temporal pattern in order to find respective times of flight for the points in the scene.

In some embodiments, the one or more detectors include one or more avalanche photodiodes, for example an array of single-photon avalanche photodiodes (SPADs).

Additionally or alternatively, the temporal pattern includes a pseudo-random pattern.

In some embodiments, the apparatus includes a scanner, which is configured to scan the pulses of optical radiation over the scene, wherein the controller is configured to drive the laser to emit the pulses in different, predefined temporal patterns toward different points in the scene. In one such embodiment, the one or more detectors include an array of detectors, and the apparatus includes objective optics, which are configured to focus a locus in the scene that is illuminated by each of the pulses onto a region of the array containing multiple detectors. Typically, the control and processing circuitry is configured to sum the output signals over the region in order to find the times of flight.

In a disclosed embodiment, the controller is configured to detect multiple echoes in correlating the output signals with the temporal pattern, each echo corresponding to a different time of flight.

In some embodiments, the controller is configured to construct a depth map of the scene based on the times of flight.

In a disclosed embodiment, the functions of the control and processing circuitry are combined and implemented monolithically on a single integrated circuit.

There is also provided, in accordance with an embodiment of the invention, a method for depth sensing, which includes emitting a sequence of pulses of optical radiation toward a scene in a predefined temporal pattern that specifies irregular intervals between the pulses in the sequence. The optical radiation that is reflected from points in the scene is received at one or more detectors, which output signals indicative of respective times of arrival of the received radiation. The output signals are correlated with the temporal pattern in order to find respective times of flight for the points in the scene.

The present invention will be more fully understood from the following detailed description of the embodiments thereof, taken together with the drawings in which:

### BRIEF DESCRIPTION OF THE DRAWINGS

FIG. 1 is a schematic side view of a depth mapping device, in accordance with an embodiment of the invention;

FIG. 2 is a plot that schematically illustrates a sequence of transmitted laser pulses, in accordance with an embodiment of the invention;

FIG. 3 is a plot that schematically illustrates signals received due to reflection of the pulse sequence of FIG. 2 from a scene, in accordance with an embodiment of the invention;

FIG. 4 is a plot that schematically illustrates a cross-correlation between the pulse sequence of FIG. 2 and the received signals of FIG. 3, in accordance with an embodiment of the invention;

FIG. 5 is a flow chart that schematically illustrates a method for multi-echo correlation, in accordance with an embodiment of the invention;

FIG. 6 is a plot that schematically illustrates a cross-correlation between a sequence of transmitted laser pulses and signals received due to reflection of the pulses from a scene, in accordance with another embodiment of the invention; and

FIG. 7 is a schematic frontal view of an array of ToF detector elements, in accordance with an embodiment of the invention.

### DETAILED DESCRIPTION OF EMBODIMENTS

The quality of measurement of the distance to each point in a scene using a LiDAR is often compromised in practical implementations by a number of environmental, fundamental, and manufacturing challenges. An example of environmental challenges is the presence of uncorrelated background light, such as solar ambient light, in both indoor and outdoor applications, typically reaching an irradiance of 1000 W/m². Fundamental challenges are related to losses incurred by optical signals upon reflection from the surfaces in the scene, especially due to low-reflectivity surfaces and limited optical collection aperture, as well as electronic and photon shot noises. These limitations often generate inflexible trade-off relationships that can push the designer to resort to solutions involving large optical apertures, high optical power, narrow field-of-view (FoV), bulky mechanical construction, low frame rate, and the restriction of sensors to operation in controlled environments.

Some ToF-based LiDARs that are known in the art operate in a single-shot mode: A single laser pulse is transmitted toward the scene for each pixel that is to appear in the depth image. The overall pixel signal budget is thus concentrated in this single pulse. This approach has the advantages that the pixel acquisition time is limited to a single photon roundtrip time, which can facilitate higher measurement throughput and/or faster frame-rate, while the amount of undesired optical power reaching the sensor due to ambient light is limited to a short integration time. On the negative side, however, the single-shot mode requires ultra-high peak power laser sources and is unable to cope with interference that may arise when multiple LiDARs are operating in the same environment, since the optical receiver cannot readily discriminate its own signal from that of the other LiDARs.

As an alternative, some LiDARs can be configured for multi-shot operation, in which several pulses are transmitted toward the scene for each imaging pixel. This approach has the advantage of working with lower peak laser pulse power. To avoid confusion between the echoes of successive transmitted pulses, however, the time interval between successive pulses is generally set to be no less than the expected maximum ToF value. In long-range LiDAR systems, the expected maximum ToF will be correspondingly large (for example, on the order of 1 μs for a range of 100 m). Consequently, the multi-shot approach can incur pixel acquisition times that are N times longer than the single-shot approach (wherein N is the number of pulses per pixel), thus resulting in lower throughput and/or lower frame-rate, as well as higher background due to longer integration of ambient radiation. Furthermore, this sort of multi-shot approach remains sensitive to interference from other LiDARs.

Embodiments of the present invention that are described herein provide a multi-shot LiDAR that is capable of both increasing throughput, relative to the sorts of multi-shot approaches that are described above, and mitigating interference between signals of different LiDARs. Some of these embodiments take advantage of the principles of code-division multiple access (CDMA) to ensure that signals of different LiDARs operating in the same environment are readily distinguishable by the respective receivers. For this purpose, the LiDAR transmitters output sequences of pulses in different, predefined temporal patterns that are encoded by means of orthogonal codes, such as pseudo-random codes having a narrow ambiguity function. Each LiDAR receiver uses its assigned code in filtering the pulse echoes that it receives, and is thus able to distinguish the pulses emitted by its corresponding transmitter from interfering pulses due to other LiDARs having different pulse transmission patterns.

In the disclosed embodiments, depth-sensing apparatus comprises a laser, which emits pulses of optical radiation toward a scene, and one or more detectors, which receive the optical radiation that is reflected from points in the scene and output signals indicative of respective times of arrival of these echo pulses. A controller drives the laser to emit the pulses sequentially in a predefined temporal pattern that specifies irregular intervals between the pulses in the sequence. The output signals from the detectors are correlated with the temporal pattern of the transmitted sequence in order to find respective times of flight for the points in the scene. These times of flight are used, for example, in constructing a depth map of the scene.

When this approach is used, the intervals between the successive pulses in the sequence can be short, i.e., considerably less than the expected maximum ToF, because the correlation operation inherently associates each echo with the corresponding transmitted pulse. Consequently, the disclosed embodiments enable higher throughput and lower integration time per pixel, thus reducing the background level relative to methods that use regular inter-pulse intervals. The term “irregular” is used in the present context to mean that the inter-pulse intervals vary over the sequence of pulses that is transmitted toward any given point in the scene. A pseudo-random pattern of inter-pulse intervals, as is used in CDMA, can be used advantageously as an irregular pattern for the present purposes, but other sorts of irregular patterns may alternatively be used.

This use of irregular inter-pulse intervals enables multiple LiDARs to operate simultaneously in the same environment. LiDARs operating in accordance with such embodiments are robust against uncontrolled sources of signal interference, and enable fast ToF evaluation with high signal-to-noise ratio by integrating less ambient light than methods using regular pulse sequences.

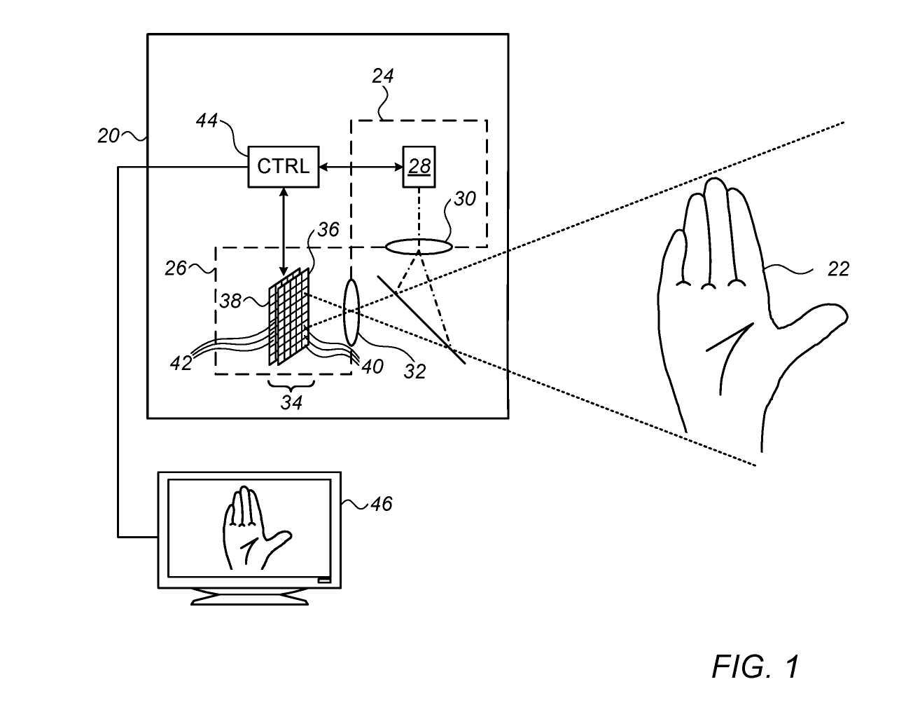

FIG. 1 is a schematic side view of a depth mapping device 20, in accordance with an embodiment of the invention. In the pictured embodiment, device 20 is used to generate depth maps of a scene including an object 22, for example a part of the body of a user of the device. To generate the depth map, an illumination assembly 24 directs pulses of light toward object 22, and an imaging assembly measures the ToF of the photons reflected from the object. (The term “light,” as used in the present description and in the claims, refers to optical radiation, which may be in any of the visible, infrared, and ultraviolet ranges.)

Illumination assembly 24 typically comprises a pulsed laser 28, which emits short pulses of light, with pulse duration in the nanosecond range and repetition frequency in the range of 50 MHz. Collection optics 30 direct the light toward object 22. Alternatively, other pulse durations and repetition frequencies may be used, depending on application requirements. In some embodiments, illumination assembly 24 comprises a scanner, such as one or more rotating mirrors (not shown), which scans the beam of pulsed light across the scene. In other embodiments, illumination assembly comprises an array of lasers, in place of laser 28, which illuminates a different parts of the scene either concurrently or sequentially. More generally, illumination assembly 24 may comprise substantially any pulsed laser or laser array that can be driven to emit sequences of pulses toward object 22 at irregular intervals.

Imaging assembly 26 comprises objective optics 32, which image object 22 onto a sensing array 34, so that photons emitted by illumination assembly 24 and reflected from object 22 are incident on the sensing device. In the pictured embodiment, sensing array 34 comprises a sensor chip 36 and a processing chip 38, which are coupled together, for example, using chip stacking techniques that are known in the art. Sensor chip 36 comprises one or more high-speed photodetectors, such as avalanche photodiodes.

In some embodiments, the photodetectors in sensor chip 36 comprise an array of SPADs 40, each of which outputs a signal indicative of the times of incidence of photons on the SPAD following emission of pulses by illumination assembly 24. Processing chip 38 comprises an array of processing circuits 42, which are coupled respectively to the sensing elements. Both of chips 36 and 38 may be produced from silicon wafers using well-known CMOS fabrication processes, based on SPAD sensor designs that are known in the art, along with accompanying drive circuits, logic and memory. For example, chips 36 and 38 may comprise circuits as described in U.S. Patent Application Publication 2017/0052065 and/or U.S. patent application Ser. No. 14/975,790, filed Dec. 20, 2015, both of whose disclosures are incorporated herein by reference. Alternatively, the designs and principles of detection that are described herein may be implemented, mutatis mutandis, using other circuits, materials and processes. All such alternative implementations are considered to be within the scope of the present invention.

Imaging assembly 26 outputs signals that are indicative of respective times of arrival of the received radiation at each SPAD 40 or, equivalently, from each point in the scene that is being mapped. These output signals are typically in the form of respective digital values of the times of arrival that are generated by processing circuits 42, although other signal formats, both digital and analog, are also possible. A controller 44 reads out the individual pixel values and generates an output depth map, comprising the measured ToF—or equivalently, the measured depth value—at each pixel. The depth map is typically conveyed to a receiving device 46, such as a display or a computer or other processor, which segments and extracts high-level information from the depth map.

As explained above, controller 44 drives the laser or lasers in illumination assembly 24 to emit sequences of pulses in a predefined temporal pattern, with irregular intervals between the pulses in the sequence. The intervals may be pseudo-random or may conform to any other suitable pattern. Processing chip 38 then finds the respective times of flight for the points in the scene by correlating the output signals from imaging assembly 26 with the predefined temporal pattern that is shared with controller 44. This correlation may be carried out by any suitable algorithm and computational logic that are known in the art. For example, processing chip 38 may compute a cross-correlation between the temporal pattern and the output signals by filtering a histogram of photon arrival times from each point in the scene with a finite-impulse-response (FIR) filter kernel that matches the temporal pattern of the transmitted pulses.

Although the present description relates to controller and processing chip 38 as separate entities, with a certain division of functions between the controller and processing chip, in practice these entities and their functions may be combined and implemented monolithically on the same integrated circuit. Alternatively, other divisions of functionality between these entities will also be apparent to those skilled in the art and are considered to be within the scope of the present invention. Therefore, in the present description and in the claims, controller 44 and processing chip 38 are referred to collectively as “control and processing circuitry,” and this term is meant to encompass all implementations of the functionalities that are attributed to these entities.

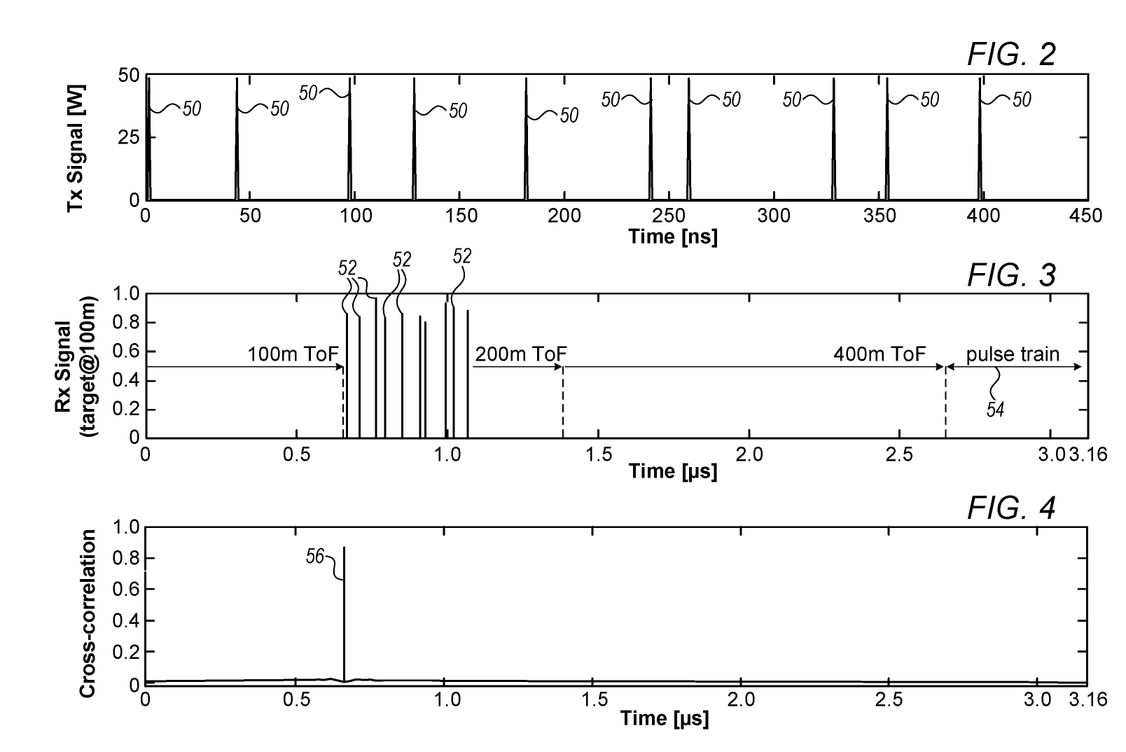

FIG. 2 is a plot that schematically illustrates a sequence of laser pulses 50 transmitted by illumination assembly 24, while FIG. 3 is a plot that schematically illustrates signals 52 received by imaging assembly 26 due to reflection of the pulse sequence of FIG. 2 from a scene, in accordance with an embodiment of the invention. The time scales of the two plots are different, with FIG. 2 running from 0 to 450 ns, while FIG. 3 runs from 0 to about 3 ps.

In this example, it is assumed that objects of interest in the scene are located roughly 100 m from mapping device 20, meaning that the time of flight of laser pulses transmitted to the scene and reflected back to device 20 is on the order of 0.7 ps, as illustrated by the timing of signals 52 in FIG. 3. The delay between successive pulses in the transmitted pulse sequence, however, is considerably shorter, varying irregularly between about 10 ns and 45 ns, as shown by pulses 50 in FIG. 2. The transmitted pulse sequence of FIG. 2 results in the irregular sequence of received signals that is shown in FIG. 3. Because the intervals between pulses are considerably shorter than the times of flight of the pulses, it is difficult to ascertain a priori which transmitted pulse gave rise to each received pulse (and thus to measure the precise time of flight of each received pulse). This ambiguity is resolved by the correlation computation that is described below.

The pulse sequence that is shown in FIG. 2 can be retransmitted periodically. In order to avoid possible confusion between successive transmissions of the pulse sequence, the period between transmissions is set to be greater than the maximum expected time of flight. Thus, in the example shown in FIG. 3, the maximum distance to objects in the scene is assumed to be 400 m, giving ToF=2.67 ps. Adding a time budget 54 of approximately 0.5 ps to accommodate the length of the pulse sequence itself gives an inter-sequence period of 3.167 μs, allowing more than 300,000 repetitions/second.

FIG. 4 is a plot that schematically illustrates a cross-correlation between the pulse sequence of FIG. 2 and the received signals of FIG. 3, in accordance with an embodiment of the invention. The cross-correlation is computed in this example by convolving the sequence of received signal pulses with a filter kernel corresponding to the predefined transmission sequence. The resulting cross-correlation has a sharp peak 56 at 666.7 ns, corresponding to the delay between the transmitted and received signal pulses. The location of this correlation peak indicates that the object giving rise to the reflected radiation was located at a distance of 100 m from device 20.

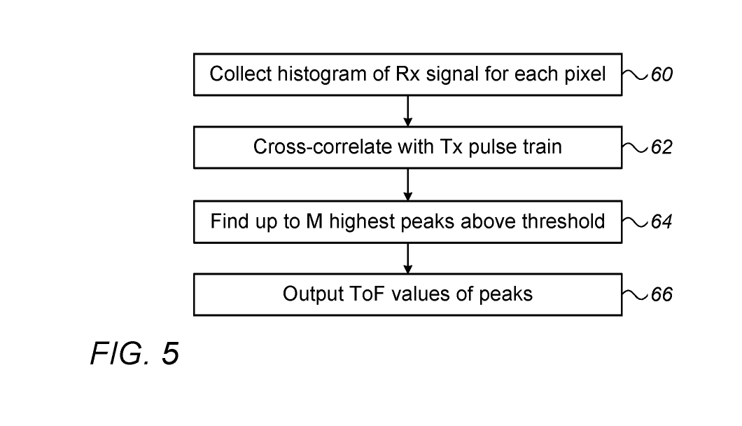

FIG. 5 is a flow chart that schematically illustrates a method for multi-echo correlation, in accordance with an embodiment of the invention. The method is carried out by control and processing circuitry, which may be embodied in processing chip 38, controller 44, or in the processing chip and controller operating together. For each SPAD 40, corresponding to a pixel in the depth map that is to be generated, the control and processing circuitry collects a histogram of the arrival times of signals 52 over multiple transmitted trains of pulses 50, at a histogram collection step 60. For each pixel, the control and processing circuitry computes cross-correlation values between this histogram and the known timing of the transmitted pulse train, at a cross-correlation step 62. Each cross-correlation value corresponds to a different time offset between the transmitted and received pulse trains.

The control and processing circuitry sorts the cross-correlation values at each pixel in order to find peaks above a predefined threshold, and selects the M highest peaks, at a peak finding step 64. (Typically, M is a small predefined integer value.) Each of these peaks is treated as an optical echo from the scene, corresponding to a different time of flight. Although in many cases there will be only a single strong echo at any given pixel, multiple echoes may occur, for example, when the area of a given detection pixel includes objects (or parts of objects) at multiple different distances from device 20. Based on the peak locations, the control and processing circuitry outputs a ToF value for each pixel, at a depth map output step 6.

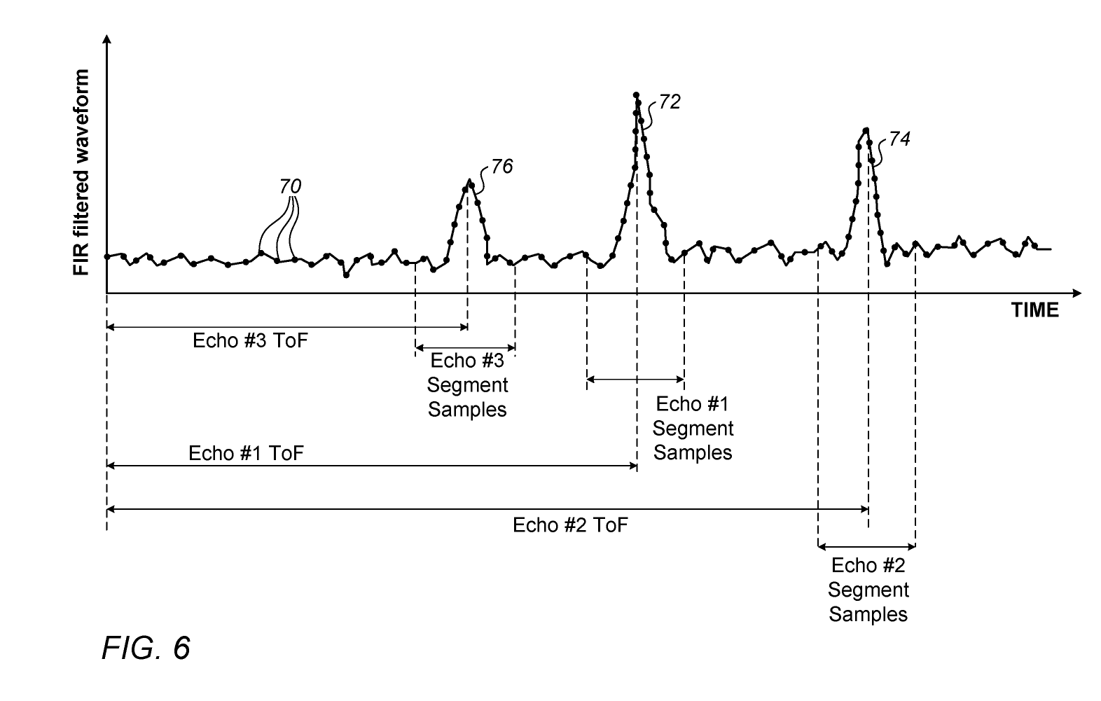

FIG. 6 is a plot that schematically illustrates a cross-correlation that is computed in this fashion between a sequence of transmitted laser pulses and signals received due to reflection of the pulses from a scene, in accordance with another embodiment of the invention. Each point 70 in the plot corresponds to a different time offset between the transmitted and received beams. As illustrated in this figure, processing chip 38 is able to detect multiple echoes, represented by peaks 72, 74, 76 in the resulting cross correlation of the output signals from imaging assembly 26 with the temporal pattern of pulses transmitted by illumination assembly 24.

In the example shown in FIG. 6, however, only three such echoes are shown, corresponding to the three correlation peaks in the figure. Alternatively, larger or smaller numbers of echoes may be detected and tracked by this method.

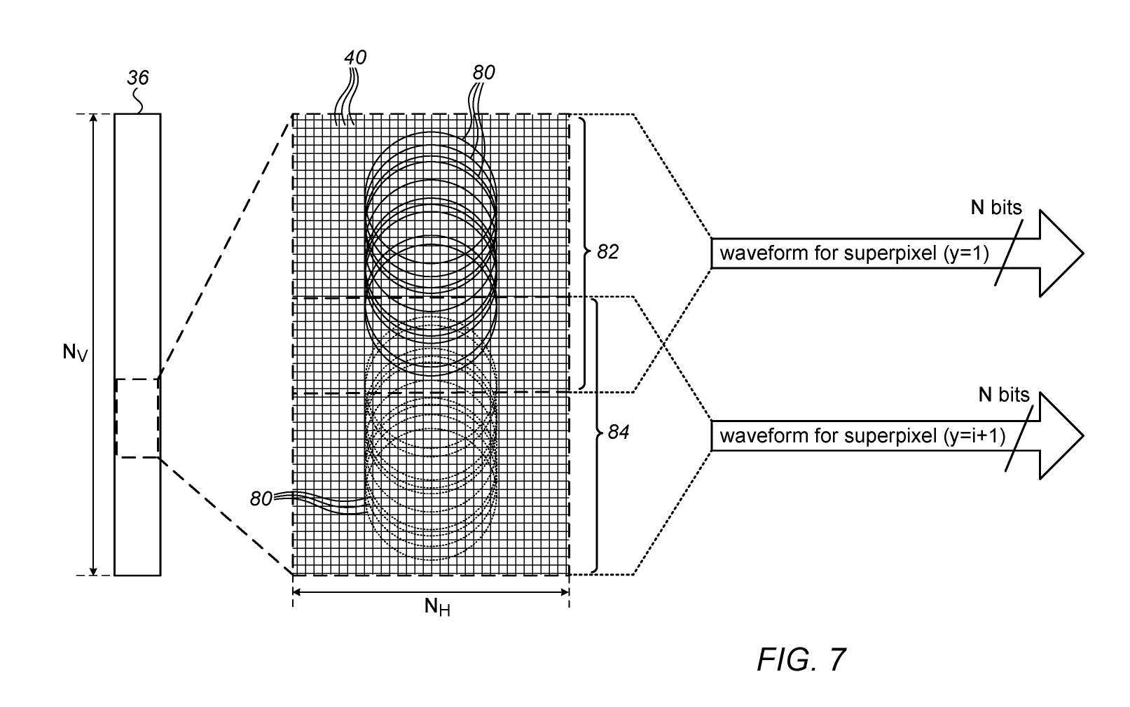

FIG. 7 is a schematic frontal view of an array of ToF detector elements, such as SPADs 40 on sensor chip 36, in accordance with a further embodiment of the invention. In this embodiment, illumination assembly 24 comprises a scanner, which scans the pulses of optical radiation that are output by laser 28 over the scene of interest. Controller 44 drives the laser to emit the pulses in different, predefined temporal patterns toward different points in the scene. In other words, the controller drives laser 28 to change the temporal pulse pattern in the course of the scan.

This approach is advantageous particularly in enhancing the spatial resolution of the ToF measurement. In the embodiment of FIG. 7, for example, the locus of each illumination spot 80 on the scene is focused by objective optics 32 onto a region of sensor chip 36 that contains a large number of neighboring SPADs. (In this case, the region of sensitivity of the array may be scanned along with the illumination spot by appropriately setting the bias voltages of the SPADs in synchronization with the scanning of a laser beam, as described in the above-mentioned U.S. patent application Ser. No. 14/975,790.) The SPADs in each region 82, 84 onto which the illumination spot is focused are treated as a “superpixel,” meaning that their output ToF signals are summed to give a combined signal waveform for the illumination spot location in question. For enhanced resolution, successive superpixels overlap one another as shown in FIG. 7.

In order to avoid confusion of the received signals from different spot locations on the scene, controller 44 drives laser 28 so that each superpixel has its own temporal pattern, which is different from the neighboring superpixels. Processing chip 38 (which shares the respective temporal patterns with controller 44) then correlates the output signal from each superpixel with the temporal pattern used at the corresponding spot location. Thus, in this case, the use of irregular inter-pulse intervals is useful not only in mitigating interference and enhancing throughput, but also in supporting enhanced spatial resolution of ToF-based depth mapping.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Depth-sensing apparatus, comprising:
a laser, which is configured to emit pulses of optical radiation toward a scene;
one or more detectors, which are configured to receive the optical radiation that is reflected from points in the scene and to output signals indicative of respective times of arrival of the received radiation; and
control and processing circuitry, which is coupled to drive the laser to emit a sequence of the pulses in a predefined temporal pattern that specifies irregular intervals between the pulses in the sequence, and to correlate the output signals with the temporal pattern in order to find respective times of flight for the points in the scene,
wherein the control and processing circuitry is configured to detect, at a given point, multiple echoes in correlating the output signals with the temporal pattern, each echo corresponding to a different time of flight for the given point.

2. The apparatus according to claim 1, wherein the one or more detectors comprise one or more avalanche photodiodes.

3. The apparatus according to claim 2, wherein the one or more avalanche photodiodes comprise an array of single-photon avalanche photodiodes (SPADs).

4. The apparatus according to claim 1, wherein the temporal pattern comprises a pseudo-random pattern.

5. The apparatus according to claim 1, and comprising a scanner, which is configured to scan the pulses of optical radiation over the scene, wherein the controller is configured to drive the laser to emit the pulses in different, predefined temporal patterns toward different points in the scene.

6. The apparatus according to claim 5, wherein the one or more detectors comprise an array of detectors, and wherein the apparatus comprises objective optics, which are configured to focus a locus in the scene that is illuminated by each of the pulses onto a region of the array containing multiple detectors.

7. The apparatus according to claim 6, wherein the control and processing circuitry is configured to sum the output signals over the region in order to find the times of flight.

8. (canceled)

9. The apparatus according to claim 1, wherein the controller is configured to construct a depth map of the scene based on the times of flight.

10. The apparatus according to claim 1, wherein the functions of the control and processing circuitry are combined and implemented monolithically on a single integrated circuit.

11. A method for depth sensing, comprising:
emitting a sequence of pulses of optical radiation toward a scene in a predefined temporal pattern that specifies irregular intervals between the pulses in the sequence;
receiving the optical radiation that is reflected from points in the scene at one or more detectors, which output signals indicative of respective times of arrival of the received radiation; and
correlating the output signals with the temporal pattern in order to find respective times of flight for the points in the scene,
wherein correlating the output signals comprises detecting, at a given point, multiple echoes in correlating the output signals with the temporal pattern, each echo corresponding to a different time of flight for the given point.

12. The method according to claim 11, wherein the one or more detectors comprise one or more avalanche photodiodes.

13. The method according to claim 12, wherein the one or more avalanche photodiodes comprise an array of single-photon avalanche photodiodes (SPADs).

14. The method according to claim 11, wherein the temporal pattern comprises a pseudo-random pattern.

15. The method according to claim 11, wherein emitting the sequence of pulses comprises scanning the pulses of optical radiation over the scene, while emitting the pulses in different, predefined temporal patterns toward different points in the scene.

16. The method according to claim 15, wherein the one or more detectors comprise an array of detectors, and wherein receiving the optical radiation comprises focusing a locus in the scene that is illuminated by each of the pulses onto a region of the array containing multiple detectors.

17. The method according to claim 16, wherein correlating the output signals comprises summing the output signals over the region in order to find the times of flight.

18. (canceled)

19. The method according to claim 11, and comprising constructing a depth map of the scene based on the times of flight.
